(19) United States
(12) Patent Application Publication
(10) Pub. No.: US 2026/0331824 A1
(43) Pub. Date: Oct. 22, 2026

(54) CONNECTOR

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Yuta KANEMATSU, Mie (JP); Sunghyun BYUN, Mie (JP); Nobukazu HIROWAKI, Mie (JP)

(21) Appl. No.: 19/109,567

(22) PCT Filed: Aug. 31, 2023
(86) PCT No.: PCT/JP2023/031817

§ 371 Date: Mar. 7, 2025

(30) Foreign Application Priority Data
Sep. 14, 2022 (JP) 2022-146049

(51) Int. Cl. H01R 13/58

(52) U.S. Cl. CPC H01R 13/582

(57) ABSTRACT

A connector includes a plurality of terminals, a plurality of wires and a back retainer made of synthetic resin and to be assembled with a connector housing. The back retainer includes divided retainers. Each of the divided retainers includes a divided protrusion to be located between the plurality of wires. By fixing the divided retainers to each other, the divided protrusions are combined to configure a wire pressing protrusion arranged between the plurality of wires. The wire pressing protrusion includes first band mounting portions. The plurality of wires are bundled and fixed to each other while being respectively held in close contact with the wire pressing protrusion and the respective divided protrusions are pressed against each other from both sides in a first direction by a first binding band wound around between the first band mounting portions.

### TECHNICAL FIELD

The present disclosure relates to a connector.

### BACKGROUND

Conventionally, a connector has been used to electrically connect in-vehicle devices. Such a connector includes a connector housing, a terminal accommodated in the connector housing and a wire connected to the terminal, and the wire is pulled out to outside through a wire pull-out opening of the connector housing. If an external force applied to the wire pulled out to outside is transmitted to the terminal side, problems such as fine sliding wear between contact points occur. Accordingly, to suppress the application of an external force applied to the wire to the terminal, a back retainer made of resin is provided which holds the wire in the connector housing while suppressing the swing of the wire, for example, in Patent Document 1.

### PRIOR ART DOCUMENT

### Patent Document

Patent Document 1: JP 2022-078600 A

### SUMMARY OF THE INVENTION

### Problems to be Solved

The back retainer is configured by combining a pair of divided retainers to be assembled with each other with the wire held therebetween in a direction perpendicular to an axis of the wire. Thus, the divided retainers tend to be open with respect to each other due to the repeated transmission of vibration from the wire to the back retainer, a creep phenomenon under a high-temperature environment or the like, a gap is formed between the back retainer and the wire and an external force transmitted to the wire may be possibly applied to the terminal side. Particularly, if the wire is enlarged in diameter due to higher voltages of in-vehicle devices, a possibility of forming the gap is thought to increase.

Accordingly, a connector is disclosed which can suppress the transmission of an external force transmitted to a wire to a terminal side by suppressing opening between divided retainers.

### Means to Solve the Problem

The present disclosure is directed to a connector with a plurality of terminals accommodated in a connector housing, a plurality of wires respectively connected to the plurality of terminals, the plurality of wires being pulled out in parallel to outside of the connector housing while being separated from each other across a gap, and a back retainer made of synthetic resin, the back retainer including a plurality of wire inserting tube portions for holding the plurality of wires pulled out to the outside of the connector housing, the plurality of wires being press-fit and inserted into the plurality of wire inserting tube portions, the back retainer being assembled with the connector housing, the back retainer including a pair of divided retainers to be fixed to each other while sandwiching and holding the wires from both sides in a direction perpendicular to an axis of each wire, each of the pair of divided retainers including a plurality of recessed grooves to be respectively held in close contact with outer peripheral surfaces of the plurality of wires and a divided protrusion located between the plurality of recessed grooves in a parallel direction of the plurality of wires and projecting in a pull-out direction of the plurality of wires, the pair of divided retainers being fixed to each other to define the plurality of wire inserting tube portions arranged in parallel by the plurality of recessed grooves, the divided protrusions being combined to configure a wire pressing protrusion arranged between the plurality of wires projecting from the plurality of wire inserting tube portions and extending in the pull-out direction, the wire pressing protrusion including a pair of wire contact surfaces to be held in contact with the wires arranged on both sides in the parallel direction and a pair of first band mounting portions provided on end surfaces on both sides in a first direction orthogonal to facing directions of the pair of wire contact surfaces, and the plurality of wires projecting from the plurality of wire inserting tube portions and extending in the pull-out direction being bundled and fixed to each other by a first binding band wound around between the pair of first band mounting portions while being respectively held in close contact with the pair of wire contact surfaces of the wire pressing protrusion of the back retainer, the first binding band contacting the pair of first band mounting portions from the both sides in the first direction to press the respective divided protrusions of the pair of divided retainers constituting the wire pressing protrusion from the both sides in the first direction.

### Effect of the Invention

According to the connector of the present disclosure, the transmission of an external force transmitted to the wire to the terminal side can be suppressed by suppressing opening between the divided retainers.

### BRIEF DESCRIPTION OF THE DRAWINGS

FIG. 1 is a perspective view of a connector according to one embodiment.

FIG. 2 is a plan view enlargedly showing an essential part in the connector shown in FIG. 1.

FIG. 3 is a section along III-III in FIG. 2.

FIG. 4 is a section along IV-IV in FIG. 2.

FIG. 5 is a section along V-V in FIG. 2.

FIG. 6 is an exploded perspective view showing the connector shown in FIG. 1 in a partially disassembled state.

FIG. 7 is a transverse section, corresponding to FIG. 3, showing a state where a back retainer is removed from the connector shown in FIG. 1.

FIG. 8 is a perspective view showing a divided retainer constituting the connector shown in FIG. 1.

FIG. 9 is a perspective view showing the divided retainer shown in FIG. 8 when viewed from a bottom surface side.

FIG. 10 is a plan view of the divided retainer shown in FIG. 8.

FIG. 11 is a front view of the divided retainer shown in FIG. 8.

FIG. 12 is a perspective view showing the back retainer constituting the connector shown in FIG. 1 when viewed from a back surface side.

### DETAILED DESCRIPTION TO EXECUTE THE INVENTION

### Description of Embodiments of Present Disclosure

First, embodiments of the present disclosure are listed and described.

(1) The connector of the present disclosure is provided with a plurality of terminals accommodated in a connector housing, a plurality of wires respectively connected to the plurality of terminals, the plurality of wires being pulled out in parallel to outside of the connector housing while being separated from each other across a gap, and a back retainer made of synthetic resin, the back retainer including a plurality of wire inserting tube portions for holding the plurality of wires pulled out to the outside of the connector housing, the plurality of wires being press-fit and inserted into the plurality of wire inserting tube portions, the back retainer being assembled with the connector housing, the back retainer including a pair of divided retainers to be fixed to each other while sandwiching and holding the wires from both sides in a direction perpendicular to an axis of each wire, each of the pair of divided retainers including a plurality of recessed grooves to be respectively held in close contact with outer peripheral surfaces of the plurality of wires and a divided protrusion located between the plurality of recessed grooves in a parallel direction of the plurality of wires and projecting in a pull-out direction of the plurality of wires, the pair of divided retainers being fixed to each other to define the plurality of wire inserting tube portions arranged in parallel by the plurality of recessed grooves, the divided protrusions being combined to configure a wire pressing protrusion arranged between the plurality of wires projecting from the plurality of wire inserting tube portions and extending in the pull-out direction, the wire pressing protrusion including a pair of wire contact surfaces to be held in contact with the wires arranged on both sides in the parallel direction and a pair of first band mounting portions provided on end surfaces on both sides in a first direction orthogonal to facing directions of the pair of wire contact surfaces, and the plurality of wires projecting from the plurality of wire inserting tube portions and extending in the pull-out direction being bundled and fixed to each other by a first binding band wound around between the pair of first band mounting portions while being respectively held in close contact with the pair of wire contact surfaces of the wire pressing protrusion of the back retainer, the first binding band contacting the pair of first band mounting portions from the both sides in the first direction to press the respective divided protrusions of the pair of divided retainers constituting the wire pressing protrusion from the both sides in the first direction.

According to the connector of the present disclosure, the back retainer made of synthetic resin is composed of the pair of divided retainers fixed to each other while sandwiching and holding the wires from the both sides in the direction perpendicular to the axes of the wires, and each of the pair of divided retainers includes the plurality of recessed grooves to be held in close contact with the outer peripheral surfaces of the wires and the divided protrusion located between the plurality of recessed grooves in the parallel direction of the wires and projecting in the pull-out direction of the plurality of wires. By fixing the pair of divided retainers to each other, the plurality of wire inserting tube portions are defined by the plurality of recessed grooves and arranged in parallel, and the divided protrusions are combined to configure the wire pressing protrusion arranged between the plurality of wires projecting from the plurality of wire inserting tube portions and extending in the pull-out direction. Further, the wire pressing protrusion includes the pair of wire contact surfaces for contacting the wires arranged on the both sides in the parallel direction of the wires and the pair of first band mounting portions provided on the end surfaces on the both sides in the first direction orthogonal to the facing direction of the pair of wire contact surfaces.

The first binding band is wound around between the pair of first band mounting portions to tie the first band mounting portions, whereby the plurality of wires projecting from the plurality of wire inserting tube portions and extending in the pull-out direction can be bundled and fixed to each other with the wire pressing protrusion sandwiched therebetween while being held in close contact with the pair of wire contact surfaces of the wire pressing protrusion of the back retainer. In this way, movements of the plurality of wires projecting from the plurality of wire inserting tube portions and extending in the pull-out direction can be suppressed by bringing the wires into close contact with the pair of wire contact surfaces of the wire pressing protrusion by a binding force of the first binding band. As a result, the wires projecting from the wire inserting tube portions can be advantageously suppressed or prevented from being displaced by an external force, and the formation of gaps between the back retainer and the wires due to opening between the divided retainers can be advantageously suppressed or prevented.

In addition, the first binding band contacts the pair of first band mounting portions from the both sides in the first direction to press the respective divided protrusions of the pair of divided retainers constituting the wire pressing protrusion against each other from the both sides in the first direction. As a result, the wire pressing protrusion constituted by the respective divided protrusions of the pair of divided retainers can be held in an assembly direction by the binding force of the first binding band and the opening between the divided retainers can be more advantageously suppressed or prevented.

As just described, in the connector of the present disclosure, it is possible both to suppress movements of the wires with respect to the back retainer and to hold the divided retainers constituting the back retainer in a joined state, utilizing the binding force of the first binding band. As a result, the connector can be provided which can suppress the transmission of an external force transmitted to the wires to the terminal side by suppressing the opening between the divided retainers.

Note that the back retainer only has to be assembled on the connector housing side and, for example, may be directly assembled with the connector housing or may be indirectly assembled with the connector housing via another member assembled with the connector housing such as a shield shell made of metal for covering the outer surface of the connector housing.

Further, any shape can be adopted for the first band mounting portions and second band mounting portions to be described later if the first and second band mounting portions are so shaped that binding bands are mountable thereon, and the first and second band mounting portions may have a gutter shape, a tube shape or a frame shape.

(2) Preferably, in (1) described above, the pair of wire contact surfaces of the wire pressing protrusion are constituted by curved surfaces convex inward in the facing directions of the wire contact surfaces. This is because, by constituting the pair of wire contact surfaces by the curved surfaces convex inward in the facing directions thereof, wide contact areas of the wires and the wire contact surfaces can be ensured and an effect of holding the wires by the wire pressing protrusion arranged between the plurality of wires can be improved.

(3) Preferably, in (1) or (2) described above, a shield shell is further provided which is made of metal, covers the connector housing by being fixed to the connector housing and includes a tubular wire pull-out opening, the plurality of wires pulled out to the outside of the connector housing being pulled out through the wire pull-out opening, the back retainer being fit to the wire pull-out opening of the shield shell, the wire pull-out opening of the shield shell includes a plurality of engaged portions provided apart from each other in a circumferential direction of the wire pull-out opening, the back retainer includes a first engaging portion including squeeze ribs provided on both sides in the first direction and to be engaged with the engaged portion and a second engaging portion including squeeze ribs provided on both sides in the parallel direction and to be engaged with the engaged portion, and the first engaging portion is pressed into contact with the engaged portion via the squeeze ribs on the both sides in the first direction and the second engaging portion is pressed into contact with the engaged portion via the squeeze ribs on the both sides in the parallel direction with the back retainer fit to the wire pull-out opening.

The back retainer, in which the plurality of wires pulled out from the connector housing are press-fit, inserted and held, is fit to the wire pull-out opening of the shield shell made of metal and fixed to the connector housing. The back retainer includes the first engaging portion to be pressed into contact with the engaged portion of the wire pull-out opening via the squeeze ribs on the both sides in the first direction (e.g. both upper and lower sides) and the second engaging portion to be pressed into contact with the engaged portion of the wire pull-out opening via the squeeze ribs on the both sides in the parallel direction of the wires (e.g. both left and right sides) with the back retainer fit to the wire pull-out opening. Thus, even if the back retainer is fit to the wire pull-out opening of the shield shell with slight rattling, the first and second engaging portions are pressed into contact with the engaged portions while squeezing the squeeze ribs in both the first direction (e.g. vertical direction) and the parallel direction (e.g. lateral direction), which are two directions orthogonal to the pull-out direction (axial direction) of the wires. As a result, rattling is absorbed by the squeeze ribs and a displacement of the back retainer fit to the wire pull-out opening with respect to the wire pull-out opening is suppressed. In this way, a displacement of the back retainer with respect to the shield shell due to vibration in a vehicle can be suppressed utilizing the squeeze ribs without enlarging the connector housing and the back retainer and while making the back retainer of synthetic resin, rather than metal. Therefore, the transmission of an external force applied to the wires to the terminal side can be suppressed or hindered while the enlargement of the connector itself and a manufacturing cost increase are suppressed. External force blocking performance for suppressing the transmission of an external force from the wires by the back retainer can be improved. Particularly, since the wire pull-out opening, to which the back retainer is fit, is constituted using the shield shell made of metal, problems such as the formation of gaps due to a creep phenomenon under a high-temperature environment can be advantageously suppressed and the state of the engaging portions pressed into contact with the engaged portions via the squeeze ribs can be advantageously maintained as compared to the case where the wire pull-out opening is provided on the connector housing made of synthetic resin.

Note that an arbitrary structure can be adopted as a fitting structure of the back retainer to the wire pull-out opening of the shield shell. For example, a resilient lock piece may be provided on the back retainer and locked and fit to a lock projection provided on the shield shell.

(4) Preferably, in (3) described above, each divided retainer includes a second band mounting portion provided on an end side opposite to the divided protrusion in the pull-out direction and the back retainer configured by assembling the divided retainers with each other includes a pair of the second band mounting portions arranged on both sides in the first direction, and the pair of divided retainers are pressed against each other from the both sides in the first direction and the back retainer is tied and fixed to the wire pull-out opening of the shield shell by a second binding band wound around between the pair of second band mounting portions.

The divided retainers include the pair of second band mounting portions on sides opposite to the divided protrusions provided with the first band mounting portions in the pull-out direction, and the divided retainers can be held in the combined state by the second binding band wound around between the pair of second band mounting portions. In this way, the divided retainers can be held in the assembly direction by a binding force of the second binding band in a place separate from the divided protrusions, and the opening between the divided retainers can be more advantageously suppressed or prevented.

Further, the back retainer can be tied and fixed to the wire pull-out opening of the shield shell, utilizing the binding force of the second binding band. As a result, the transmission of an external force transmitted to the wires to the terminal side can be more advantageously suppressed by suppressing the opening between the divided retainers.

(5) Preferably, in (3) or (4) described above, the plurality of engaged portions of the wire pull-out opening include a plurality of first engaged portions arranged on the both sides in the parallel direction and a plurality of second engaged portions arranged on the both sides in the first direction, the back retainer includes a plurality of the first engaging portions arranged on the both sides in the parallel direction and a plurality of the second engaging portions arranged on the both sides in the first direction, and the first engaging portions are pressed into contact with the first engaged portions on the both sides in the parallel direction via the squeeze ribs on the both sides in the first direction and the second engaging portions are pressed into contact with the second engaged portions on the both sides in the first direction via the squeeze ribs on the both sides in the parallel direction with the back retainer fit to the wire pull-out opening.

This is because the engaging portions can be pressed into contact with the engaged portions via the squeeze ribs on the both sides in each of the first direction and the parallel direction, and the transmission of an external force transmitted to the wires to the terminal side can be more advantageously suppressed or hindered by more stably suppressing a displacement of the back retainer with respect to the shield shell.

(6) Preferably, in any one of (1) to (5) described above, a diameter of an inner peripheral surface of each wire inserting tube portion of the back retainer is larger than a diameter of the outer peripheral surface of each wire inserted through inside of the wire inserting tube portion, a plurality of wire pressing protuberances projecting further radially inward than the outer peripheral surface of each wire are provided to project away from each other on the inner peripheral surface of each wire inserting tube portion, and the respective wire pressing protuberances press an insulation coating constituting the outer peripheral surface of each wire radially inward, whereby the wire is press-fit, inserted and held in the wire inserting tube portion.

The diameter of the inner peripheral surface of each wire inserting tube portion is larger than the diameter of the outer peripheral surface of each wire and a gap is formed between those peripheral surfaces. Further, the plurality of wire pressing protuberances are provided apart from each other. Thus, the insulation coating resiliently deformed radially outward by being pressed by the wire pressing protuberances can be taken up in gaps spreading between the respective wire pressing protuberances. Therefore, an assembly force in assembling the wire inserting tube portion with the wire can be reduced and assembly workability can be improved while the wire is advantageously positioned and fixed in the wire inserting tube portion by the pressing of the insulation coating by the wire pressing protuberances. Preferably, the plurality of wire pressing protuberances are desirably scattered apart from each other in both an axial direction and a circumferential direction of the wire inserting tube portion. In this way, the wire can be fixed in a wider range by being pressed by the wire pressing protuberances and the external force blocking performance for suppressing the transmission of an external force from the wire by the back retainer can be further improved.

(7) Preferably, in any one of (3) to (5) described above, the back retainer includes a resilient lock piece cantilevered toward the wire pull-out opening of the shield shell, the resilient lock piece including a fitting hole in a projecting end part, the shield shell includes a lock projection projecting on an outer peripheral surface of the wire pull-out opening, and the back retainer is fit to the wire pull-out opening of the shield shell by fitting the lock projection of the shield shell into the fitting hole of the resilient lock piece of the back retainer. Since the back retainer made of synthetic resin may be provided with the resilient lock piece and the shield shell may be formed with the lock projection, the structure of the shield shell can be simplified and manufacturing cost can be suppressed while the resilient lock piece is easily molded.

(8) Preferably, in (7) described above, the wire pull-out opening of the shield shell includes a recess-like lock piece accommodating portion open in the outer peripheral surface of the wire pull-out opening and the lock projection projects on a bottom surface of the lock piece accommodating portion, and the resilient lock piece of the back retainer is accommodated in the lock piece accommodating portion with the back retainer fit to the shield shell.

Since the resilient lock piece is accommodated in the lock piece accommodating portion of the shield shell with the back retainer fit to the shield shell, the projection of the resilient lock piece toward the outer peripheral side of the wire pull-out opening can be suppressed. In this way, unexpected separation of the back retainer from the wire pull-out opening and the like can be advantageously suppressed by suppressing the interference of the resilient lock piece with another member. Further, since the lock projection of the wire pull-out opening is also provided on the bottom surface of the lock piece accommodating portion, the interference of the lock projection with another member can be suppressed by also suppressing the projection of the lock projection toward the outer peripheral side of the wire pull-out opening. Note that, more preferably, a depth of the lock piece accommodating portion is so adjusted that the resilient lock piece does not project toward the outer peripheral side from the outer peripheral surface of the wire pull-out opening.

(9) Preferably, in (8) described above, the wire pull-out opening of the shield shell is provided with the plurality of cut-like engaged portions penetrating in a plate thickness direction and open in an end surface on the pull-out direction side of the wires in a tubular end part located on the pull-out direction side, at least one of the engaged portions is provided to be open in the bottom surface of the lock piece accommodating portion, and the second engaging portion having a projecting shape, projecting from the resilient lock piece toward the wire and to be press-fit into the at least one of the engaged portions is provided on a base end side of the resilient lock piece of the back retainer.

Since the engaged portions provided on the wire pull-out opening of the shield shell are configured into cuts penetrating in the plate thickness direction of the tubular end part and open in the end surface on the pull-out direction side of the wires, the engaged portions can be provided without enlarging the shield shell. Further, since one of the engaged portions is provided to be open in the bottom surface of the lock piece accommodating portion and the second engaging portion to be press-fit thereinto has the projecting shape projecting from the resilient lock piece toward the wire, the second engaging portion is space-efficiently provided, utilizing an open space on a back surface side of the resilient lock piece well. In this way, the engaged portion and the second engaging portion to be press-fit thereinto can be space-efficiently provided without enlarging the connector.

(10) Preferably, in (9) described above, the back retainer includes a mounting tube portion to be fit into an inner peripheral side of the tubular end part of the wire pull-out opening and the first engaging portion having a projecting shape and projecting on an outer peripheral surface of the mounting tube portion, and the first engaging portion is accommodated in the engaged portion without projecting toward an outer peripheral side of the wire pull-out opening with the back retainer fit to the shield shell.

The first engaging portion can be caused to project on the outer peripheral surface of the mounting tube portion of the back retainer to be fit into the inner peripheral side of the tubular end part of the wire pull-out opening, accommodated in the engaged portion penetrating through the tubular end part in the plate thickness direction and press-fit into the engaged portion. Thus, the engaged portion and the first engaging portion press-fit thereinto can be arranged, utilizing the tubular end part of the wire pull-out opening, and the engaged portion and the first engaging portion to be fit thereinto can be space-efficiently provided without enlarging the connector.

### Details of Embodiment of Present Disclosure

A specific example of a connector of the present disclosure is described below with reference to the drawings. Note that the present disclosure is not limited to these illustrations, but is represented by claims and intended to include all changes in the scope of claims and in the meaning and scope of equivalents.

### Embodiment

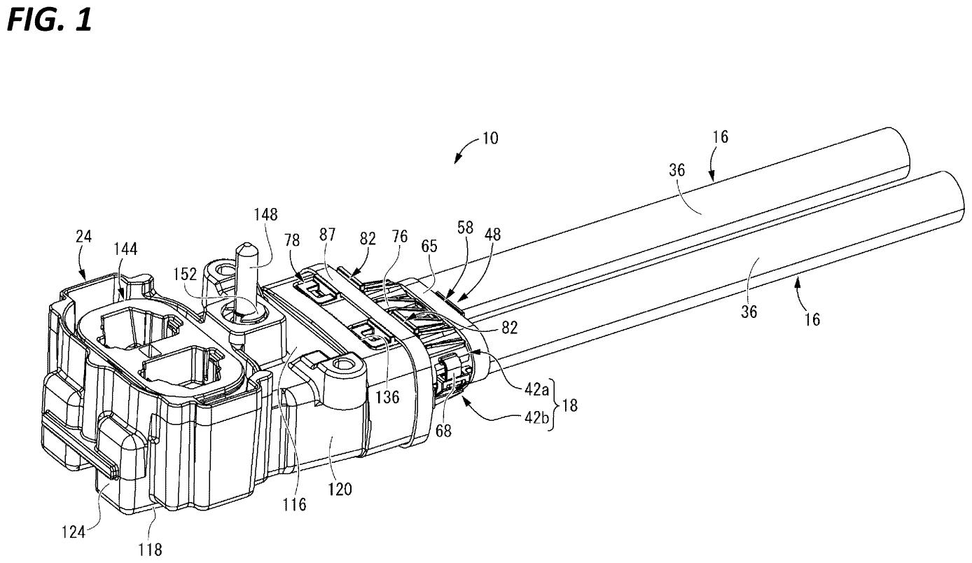

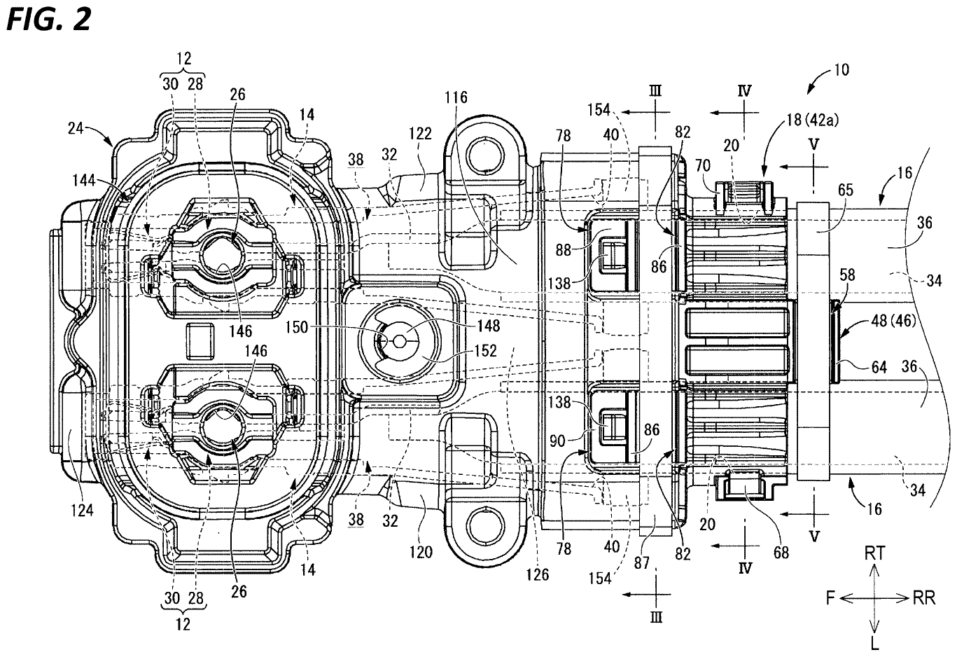

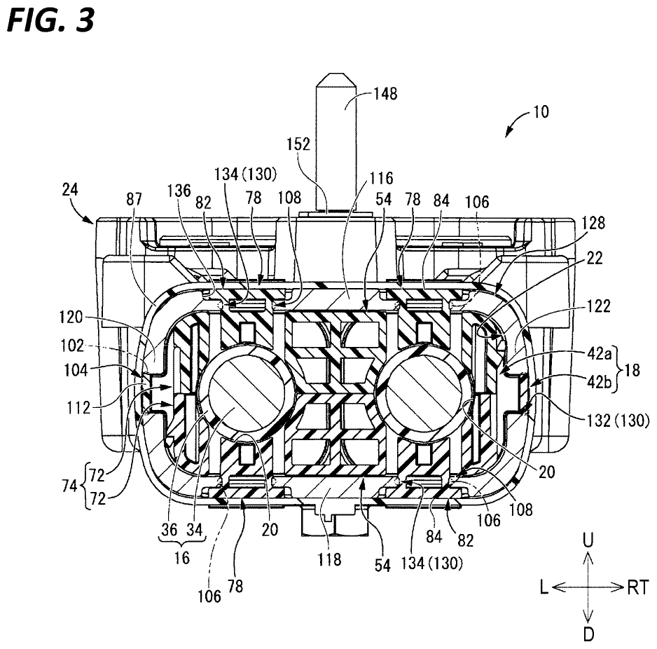

Hereinafter, a connector 10 of one embodiment of the present disclosure is described using FIGS. 1 to 12. The connector 10 includes terminals 12, and the terminals 12 in the connector 10 and mating terminals in an unillustrated mating connector are brought into an electrically conductive state by connecting the connector 10 and the mating connector. Note that the connector 10 can be arranged in an arbitrary orientation, but upper and lower sides in FIG. 3 are referred to as upper and lower sides, left and right sides in FIG. 2 are referred to as front and rear sides, and lower and upper sides in FIG. 2 are referred to as left and right sides below. Further, for a plurality of identical members, only some members may be denoted by a reference sign and the other members may not be denoted by the reference sign.

### Connector 10

As also shown in FIGS. 1 to 4, the connector 10 includes a plurality of (in this embodiment, a pair of) the terminals 12, 12 accommodated in connector housings 14 and a plurality of (in this embodiment, a pair of) wires 16, 16 respectively connected to the plurality of terminals 12 and pulled out in parallel across a gap to the outside of the connector housings 14. Further, the connector 10 includes a back retainer 18 made of synthetic resin and to be assembled with the connector housings 14, and the back retainer 18 includes a plurality of (in this embodiment, a pair of) wire inserting tube portions 20, through which the plurality of wires 16 pulled out to the outside of the connector housings 14 are press-fit, inserted and held. In this embodiment, a pair of the connector housings 14 are provided, and the terminals 12 are respectively accommodated in the connector housings 14, 14.

The respective connector housings 14, the respective terminals 12 and the respective wires 16 are arranged apart from each other in a lateral direction, and a parallel direction of the respective wires 16 is the lateral direction in this embodiment. Further, as described later, the respective wires 16 are pulled out rearward from the respective connector housings 14, and a pull-out direction of the respective wires 16 is a front-rear direction (particularly, a direction from front to rear).

Further, in this embodiment, the connector 10 is provided with a shield shell 24 made of metal, configured to cover the connector housings 14 by being fixed to the connector housing 14, and including a tubular wire pull-out opening 22, through which the plurality of wires 16 pulled out from the connector housings 14 are pulled out. The back retainer 18 is fit to the wire pull-out opening 22 of the shield shell 24.

### Terminals 12

In this embodiment, the unillustrated mating terminal to be connected to each terminal 12 is a pin terminal, and a specific structure of the terminal 12 is not limited if the terminal 12 includes a tubular connecting portion 26, into which the pin-shaped mating terminal is press-fit. For example, the structure of a female terminal (10) described in Japanese Unexamined Patent Publication No. 2021-28899 can be adopted. More particularly, each terminal 12 of this embodiment is configured to include a terminal body 28 having the tubular connecting portion 26 and a coil spring 30 serving as a resilient member to be attached to a tip part (front end part) of the terminal body 28. A wire fixing portion 32 to be fixed to the wire 16 is provided on a base end part (rear end part) of each terminal body 28.

Each wire 16 is a coated wire and composed of a core wire 34 and an insulation coating 36 made of synthetic resin for covering the core wire 34 over an entire length. The insulation coating 36 is stripped in an end of each wire 16 to expose the core wire 34 and the exposed core wire 34 is fixed to the wire fixing portion 32 of each terminal body 28, whereby each terminal body 28 and each wire 16 are connected. Note that a method for fixing the wire fixing portion 32 and the core wire 34 is not limited, but may be adhesion, welding, crimping using a crimping piece or the like.

### Connector Housings 14

As shown in FIG. 2, the connector housing 14 includes a terminal accommodating portion 38 substantially in the form of a rectangular tube for accommodating a front end part of the wire 16 and the terminal 12 fixed to the end of the wire 16. As described above, in this embodiment, the pair of connector housings 14, 14 are provided, and each connector housing 14 includes the terminal accommodating portion 38. The respective connector housings 14 (respective terminal accommodating portions 38) are separated from each other in the lateral direction, and extend in the front-rear direction. The wire 16 accommodated in each terminal accommodating portion 38 is pulled out to an outside space through a rear opening 40 of each connector housing 14 (each terminal accommodating portion 38). That is, each wire 16 is pulled out rearward from each connector housing 14, and the pull-out direction of each wire 16 is the front-rear direction (particularly, the direction from front to rear).

Note that a method for fixing these connector housings 14 and the shield shell 24 to be fixed while covering the respective connector housings 14 is not limited. In this embodiment, as described later, each connector housing 14 is inserted into the shield shell 24 through a rear opening (wire pull-out opening 22). Each connector housing 14 is fixed to the shield shell 24, for example, by fitting projections and recesses provided in or on the outer surface of each connector housing 14 and the inner surface of the shield shell 24.

### Back Retainer 18

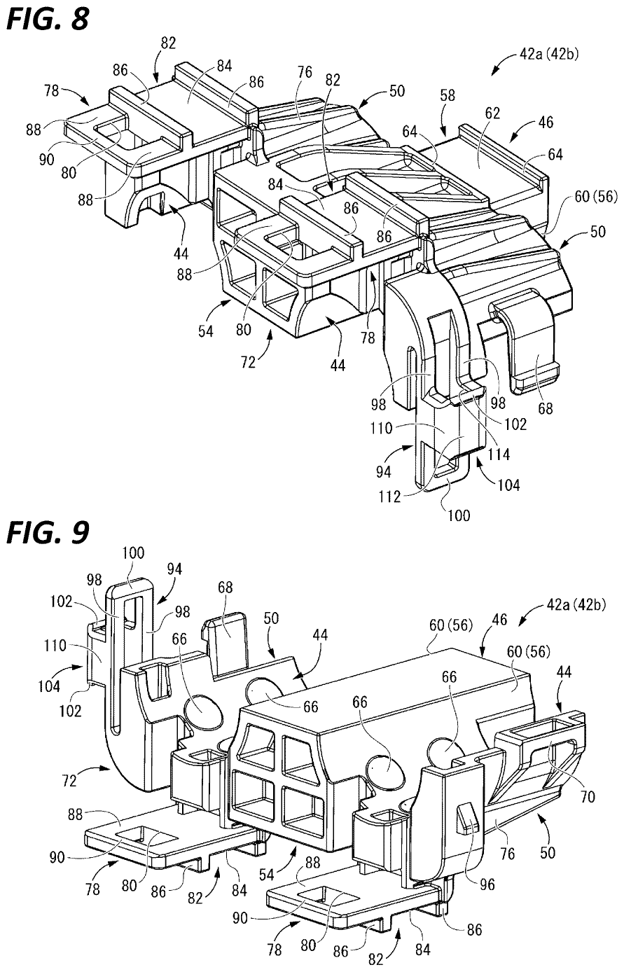

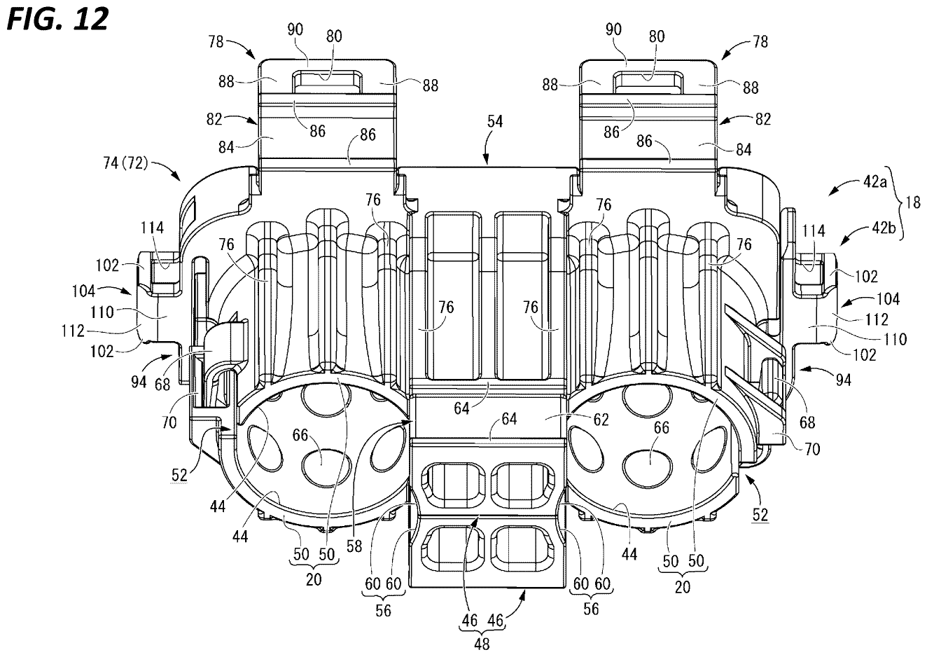

As also shown in FIG. 12, the back retainer 18 includes a pair of divided retainers 42a, 42b to be fixed to each other while sandwiching and holding the respective wires 16 from both sides in a direction perpendicular to axes of the respective wires 16 (from both vertical sides in this embodiment). Particularly, in this embodiment, the pair of divided retainers 42a, 42b have the same shape and the back retainer 18 is configured by assembling the pair of divided retainers 42a, 42b mutually inverted in a vertical direction with each other. One (upper) divided retainer 42a is described using FIGS. 8 to 11, and the other (lower) divided retainer 42b is not described below.

### Divided Retainers 42a, 42b

The divided retainer 42a includes a plurality of (in this embodiment, a pair of) recessed grooves 44, 44 to be respectively held in close contact with the outer peripheral surfaces of the respective wires 16 (outer peripheral surfaces of the respective insulation coatings 36) and a divided protrusion 46 located between the plurality of recessed grooves 44, 44 in the parallel direction of the plurality of wires 16 (lateral direction) and projecting in the pull-out direction of the plurality of wires 16 (rearward). By fixing the pair of divided retainers 42a, 42b to each other, the wire inserting tube portions 20 are defined by the upper and lower recessed grooves 44 and a plurality of (a pair of) the wire inserting tube portions 20, 20 are arranged in parallel in the lateral direction. Further, by fixing the pair of divided retainers 42a, 42b to each other, a wire pressing protrusion 48 is configured by the upper and lower divided protrusions 46, and this wire pressing protrusion 48 is arranged between the respective wires 16, which extend out in the pull-out direction (rearward) from the respective wire inserting tube portions 20, in the lateral direction.

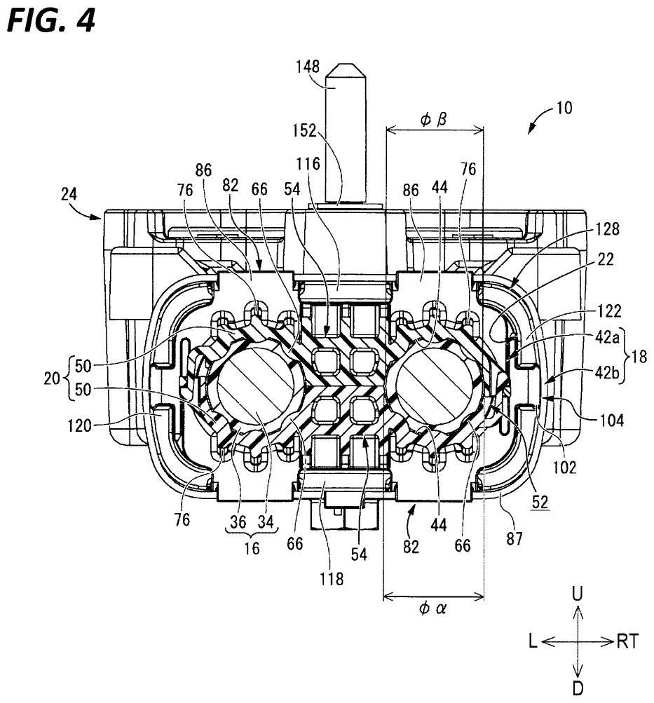

More specifically, the divided retainer 42a includes divided tube portions 50 forming the respective recessed grooves 44, and a pair of the divided tube portions 50, 50 are provided apart from each other in the lateral direction. By fixing the pair of divided retainers 42a, 42b to each other, the respective wire inserting tube portions 20 are configured by the upper and lower divided tube portions 50. Note that, in this embodiment, rear parts of the pair of divided tube portions 50, 50 provided on both left and right sides have different lengths in a circumferential direction. That is, as shown in FIG. 4, the divided tube portion 50 provided on the left side is formed to have a circumferential length shorter than half the circumference and the divided tube portion 50 provided on the right side is formed to have a circumferential length substantially equal to or slightly longer than half the circumference in the upper divided retainer 42a. In this way, when the respective wire inserting tube portions 20 are configured by overlapping the upper and lower divided tube portions 50, a gap 52 extending in the front-rear direction is formed between the upper and lower divided tube portions 50 in the circumferential direction in the rear part of each wire inserting tube portion 20.

Further, in the divided retainer 42a, the respective left and right divided tube portions 50 are coupled by a coupling portion 54. As described above, since the divided protrusion 46 is provided between the respective left and right recessed grooves 44 (respective divided tube portions 50), the divided protrusion 46 is provided in the coupling portion 54 and projects further rearward than the respective divided tube portions 50. In the upper divided retainer 42a, the lower surface of the coupling portion 54 is a flat surface, and the flat surfaces of the coupling portions 54 are overlapped each other by fixing the upper and lower divided retainers 42a, 42b to each other. Note that the respective left and right divided tube portions 50 and the coupling portion 54 may be provided with lightening portions at proper positions.

Furthermore, circumferential lengths of front parts of the pair of divided tube portions 50, 50 provided on the left and right sides are substantially half the circumference. In this way, when the respective wire inserting tube portions 20 are configured by overlapping the upper and lower divided tube portions 50, front parts of the respective wire inserting tube portions 20 have a substantially hollow cylindrical shape. In this embodiment, a diameter φα (see FIG. 4) of the inner peripheral surface of each wire inserting tube portion 20 composed of the respective upper and lower divided tube portions 50 (respective recessed grooves 44) is larger than a diameter φβ (see FIG. 4) of the outer peripheral surface of the wire 16 inserted through the inside of each wire inserting tube portion 20.

### Wire Pressing Protrusion 48

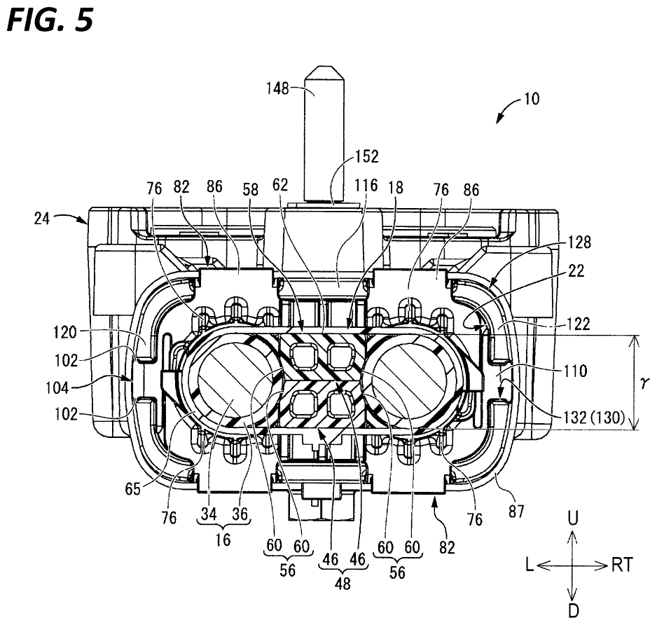

The wire pressing protrusion 48 configured by overlapping the respective divided protrusions 46 has a pair of wire contact surfaces 56, 56 arranged on both sides in the parallel direction of the respective wires 16 (lateral direction) to contact the respective wires 16 (see FIG. 5). In this embodiment, the respective wire contact surfaces 56 are constituted by curved surfaces convex inward in facing directions thereof (lateral direction), and vertical centers of the respective wire contact surfaces 56 project most inward in the lateral direction. Further, the wire pressing protrusion 48 includes a pair of first band mounting portions 58, 58 on end surfaces on both sides in a first direction orthogonal to the facing directions of the pair of wire contact surfaces 56, 56 (lateral direction), i.e. in the vertical direction. Note that, in this embodiment, a curvature of each wire contact surface 56 is substantially equal to that of the outer peripheral surface of each wire 16 (outer peripheral surface of each insulation coating 36), and each wire contact surface 56 has a curved surface shape substantially corresponding to the outer peripheral surface of each wire 16. In this way, when being held in close contact with the outer peripheral surface of each wire 16, each wire contact surface 56 is substantially entirely held in close contact with the outer peripheral surface of each wire 16.

Since the wire pressing protrusion 48 is divided into the divided protrusions 46 in the vertical direction, the respective wire contact surfaces 56 are also divided in the vertical direction and, as also shown in FIGS. 5, 12 and the like, divided contact surfaces 60 constituting the respective wire contact surfaces 56 are provided on both sides in the lateral direction of the respective divided protrusions 46. That is, in the upper divided retainer 42a, the divided contact surfaces 60 curved gradually outward in the lateral direction toward an upper side are provided on both left and right outer surfaces of a lower end part of the divided protrusion 46. The respective wire contact surfaces 56 projecting most inward in the lateral direction at vertical centers are formed by overlapping the upper and lower divided retainers 42a, 42b and making the vertically inverted divided contact surfaces 60, 60 continuous with each other in the vertical direction.

### First Band Mounting Portions 58

Further, the first band mounting portion 58 is formed on the upper end surface of the divided protrusion 46 in the upper divided retainer 42a. In this embodiment, the first band mounting portion 58 has a gutter shape extending in the lateral direction and is composed of a flat surface 62 constituted by the upper end surface of the divided protrusion 46 and extending in the lateral direction over an entire length and both side edge parts 64, 64 projecting upward from the flat surface 62 on both sides in the front-rear direction of the flat surface 62. By forming the first band mounting portion 58 on the upper end surface of the divided protrusion 46 in the divided retainer 42a in this way, the pair of first band mounting portions 58, 58 are provided on the end surfaces on the both sides in the vertical direction of the wire pressing protrusion 48 configured by overlapping the upper and lower divided protrusions 46, 46.

### First Binding Band 65

The respective wires 16 projecting and extending rearward from the respective wire inserting tube portions 20 are bundled and fixed to each other while being held in close contact with the respective wire contact surfaces 56 of the wire pressing protrusion 48 in the back retainer 18 by a first binding band 65 wound around between the respective first band mounting portions 58. Further, the first binding band 65 is in contact with the respective first band mounting portions 58 from both sides in the vertical direction and press the respective divided protrusions 46 in the upper and lower divided retainers 42a, 42b constituting the wire pressing protrusion 48 from the both sides in the vertical direction. In short, the first binding band 65 is inserted through the respective first band mounting portions 58 having a substantially gutter shape, and parts of the first binding band 65 on the both sides in the vertical direction are inserted between the both side edge parts 64 of the respective first band mounting portions 58 and overlaid on the flat surfaces 62. In this way, the detachment of the first binding band 65 from the respective first band mounting portions 58 is prevented.

Further, as shown in FIG. 5, parts of the first binding band 65 on both sides in the lateral direction are overlapped on and held in close contact with lateral outer parts of the outer peripheral surfaces of the respective wires 16 (outer peripheral surfaces of the respective insulation coatings 36). That is, the respective wires 16 are held in close contact with the wire pressing protrusion 48 and the first binding band 65 on the both sides in the lateral direction and sandwiched between these wire pressing protrusion 48 and first binding band 65. In this embodiment, a vertical dimension γ (see FIG. 5) of the wire pressing protrusion 48 is slightly larger than the diameter φβ of the outer peripheral surface of each wire 16, thereby reducing a possibility that the parts of the first binding band 65 on the both sides in the vertical direction are lifted from the flat surfaces 62 of the respective first band mounting portions 58 at the time of bundling and fixing by the first binding band 65. In this way, the upper and lower divided tube portions 50, 50 in the upper and lower divided retainers 42a, 42b are prevented from being displaced in mutually opening directions (separating directions) to form gaps between the respective wire inserting tube portions 20 and the respective wires 16 by the first binding band 65. Note that the first binding band 65 is, for example, made of synthetic resin and a conventionally known binding band can be adopted as such.

### Wire Pressing Protuberances 66

As also shown in FIGS. 4 and 9, a plurality of wire pressing protuberances 66 projecting radially inward are formed on the inner peripheral surfaces of the respective left and right divided tube portions 50 in the divided retainer 42a. In each divided tube portion 50, the plurality of wire pressing protuberances 66 are arranged apart from each other in the circumferential direction on the same circumference. Further, the plurality of wire pressing protuberances 66 arranged apart from each other in the circumferential direction on the same circumferences are arranged apart from each other at two positions in the front-rear direction. The plurality of these wire pressing protuberances 66 provided on the respective left and right divided tube portions 50 are substantially at the same positions in the front-rear direction. Thus, when the respective divided tube portions 50 are overlapped in the vertical direction to configure the respective wire inserting tube portions 20, the plurality of wire pressing protuberances 66 are arranged apart from each other in the circumferential direction substantially over the entire circumference on the same circumference in each wire inserting tube portion 20 having a substantially hollow cylindrical shape.

As shown in FIG. 4, the plurality of wire pressing protuberances 66 project further radially inward than the outer peripheral surface of each wire 16 with each wire 16 inserted through each wire inserting tube portion 20. As a result, the insulation coating 36 constituting the outer peripheral surface of each wire 16 is pressed radially inward by the respective wire pressing protuberances 66. In this way, each wire 16 is press-fit, inserted and held in each wire inserting tube portion 20. Note that since the back retainer 18 is moved forward and assembled with the shield shell 24 after the back retainer 18 is mounted on the respective wires 16 as described later in this embodiment, the back retainer 18 is enabled to be displaced in the front-rear direction with respect to the respective wires 16 while the insulation coatings 36 of the respective wires 16 are pressed by the respective wire pressing protuberances 66.

Further, in the divided retainer 42a, a lock claw portion 68 projecting downward is provided on the outer peripheral surface of a rear part of the one (left in this embodiment) divided tube portion 50, and a lock frame body 70 projecting toward an outer peripheral side is provided on the outer peripheral surface of the other (right in this embodiment) divided tube portion 50. In this way, when the upper and lower divided retainers 42a, 42b are overlapped to configure the respective wire inserting tube portions 20, the respective lock claw portions 68 and/or the respective lock frame bodies 70 are resiliently formed and engaged. As a result, the separation of the respective divided tube portions 50 is hindered and the respective wire inserting tube portions 20 are maintained to have the substantially hollow cylindrical shape.

A base portion 72 is provided in a front part of the divided retainer 42a. That is, the base portion 72 is constituted by the parts having the circumferential length of half the circumference in front parts of the respective left and right divided tube portions 50 and the coupling portion 54 provided between these divided tube portions 50. In other words, the respective left and right divided tube portions 50 and the coupling portion 54 project rearward from the base portion 72. The base portion 72 has a predetermined thickness (dimension in the front-rear direction) and has a substantially rectangular shape as a whole when viewed from the front-rear direction as also shown in FIG. 11, but has substantially semicircular recesses at positions corresponding to the respective recessed grooves 44.

Note that when the upper and lower divided retainers 42a, 42b are assembled to configure the back retainer 18, one base portion 72 and another vertically inverted base portion 72 are overlapped in the vertical direction. As shown in FIG. 3, this pair of base portions 72, 72 are overlapped in the vertical direction, thereby configuring a mounting tube portion 74 to be fit into an inner peripheral side of a later-described tubular end part 128 in the wire pull-out opening 22. That is, the mounting tube portion 74 is fit in the tubular end part 128 with the back retainer 18 assembled with the shield shell 24 to configure the connector 10.

Further, in the divided retainer 42a, a plurality of ribs 76 extending rearward from the base portion 72 are provided on the upper surfaces of the respective left and right divided tube portions 50 and the coupling portion 54 and separated from each other in the lateral direction. Each of the plurality of these ribs 76 has a substantially triangular or trapezoidal shape when viewed from the lateral direction and includes a part having a vertical dimension gradually reduced from front to rear. The respective left and right divided tube portions 50 and the coupling portion 54 are respectively reinforced by the plurality of these ribs 76.

Particularly, by making the vertical dimension of a front part larger than that of a rear part in each rib 76, a reinforcement effect in a part near the wire pull-out opening 22 is relatively strongly exhibited and a displacement of each wire 16 inserted in each wire inserting tube portion 20 near the wire pull-out opening 22 is prevented when the back retainer 18 is fit to the wire pull-out opening 22 of the shield shell 24. In contrast, by making the vertical dimension of the rear part of each rib 76 smaller than that of the front part, the respective left and right divided tube portions 50 are allowed to be resiliently deformed to a certain extent and a possibility of damaging each wire 16 when each wire 16 is largely displaced with respect to the divided tube portions 50 is reduced.

### Resilient Lock Pieces 78

Resilient lock pieces 78 cantilevered forward, i.e. toward the wire pull-out opening 22 of the shield shell 24, are provided in an upper end part of the base portion 72, and resiliently deformable in the vertical direction. A pair of the resilient lock pieces 78, 78 are provided in the divided retainer 42a, and separated from each other in the lateral direction. Specifically, the respective resilient lock pieces 78 are provided at positions corresponding to the respective left and right divided tube portions 50. Further, a substantially rectangular fitting hole 80 penetrating in the vertical direction is provided in a projecting end part (front end part) of each of these resilient lock pieces 78. In the divided retainer 42a, a second band mounting portion 82, on which a second binding band 87 to be described later is mounted, is provided in a projecting base end part (rear end part) of the upper end surface of each resilient lock piece 78.

### Second Band Mounting Portions 82

Each second band mounting portion 82 has a gutter shape extending in the lateral direction similar to the aforementioned first band mounting portion 58, and is composed of a flat surface 84 constituted by the upper end surface of the resilient lock piece 78 and extending in the lateral direction over an entire length and both side edge parts 86, 86 projecting upward from the flat surface 84 on both sides in the front-rear direction of the flat surface 84. That is, in the divided retainer 42a, the respective second band mounting portions 82 are provided on an end side (front end side) opposite to the divided protrusion 46 in the pull-out direction of the respective wires 16 (front-rear direction). By forming the respective second band mounting portions 82 on the upper end surfaces of the respective resilient lock pieces 78 in the divided retainer 42a, the respective second band mounting portions 82, 82 are provided on end surfaces on both sides in the first direction (vertical direction) of the back retainer 18 configured by overlapping the upper and lower divided retainers 42a, 42b.

### Second Binding Band 87

The upper and lower divided retainers 42a, 42b are pressed against each other from the both upper and lower sides and the back retainer 18 is tied and fixed to the wire pull-out opening 22 of the shield shell 24 by the sound binding band 87 wound around between these second band mounting portions 82. In short, the second binding band 87 is inserted through the respective second band mounting portions 82 having a substantially gutter shape, and parts of the second binding band 87 on the both sides in the vertical direction are inserted between the both side edge parts 86 of the respective second band mounting portions 82 and overlaid on the flat surfaces 84. In this way, the detachment of the second binding band 87 from the respective second band mounting portions 82 is prevented.

Further, as shown in FIG. 3, parts of the second binding band 87 on both sides in the lateral direction are overlapped on and held in close contact with lateral outer parts of the outer peripheral surfaces of the later-described tubular end part 128 of the shield shell 24. In this embodiment, the second binding band 87 is provided to cover fit parts of the back retainer 18 and the shield shell 24, i.e. engaged parts of first engaging portions 104 and first engaged portions 132 and engaged parts of second engaging portions 108 and second engaged portions 134, from outside. In this way, a possibility that vibration transmitted from outside, for example, through the wires 16 is transmitted to the back retainer 18 and the back retainer 18 and the shield shell 24 are disengaged is reduced. Note that the second binding band 87 is, for example, made of synthetic resin and a conventionally known binding band can be adopted as such.

Further, in each resilient lock piece 78, a front end part of each second band mounting portion 82 includes a pair of forward projecting portions 88, 88 separated from each other in the lateral direction and projecting forward and a connecting portion 90 connecting projecting tip parts (front end parts) of these forward projecting portions 88. The fitting hole 80 is constituted by a region surrounded by the second band mounting portion 82, the respective forward projecting portions 88 and the connecting portion 90. Further, as also shown in FIGS. 3 and 11, a pair of downward extending portions 92, 92 extending downward along the front surface of the base portion 72 are provided apart from each other in the lateral direction on the projecting base end part of each resilient lock piece 78 in the divided retainer 42a. As shown in FIGS. 3 and 11, squeeze ribs 106 in the second engaging portions 108 to be described later are provided on the lateral outer surfaces of the respective downward extending portions 92 separated from each other in the lateral direction. Note that squeeze ribs 102, 106 before being deformed are shown by two-dot chain lines in FIG. 3.

Further, in the divided retainer 42a, a resilient lock frame body 94 projecting downward is provided on the left end surface of the base portion 72 and a lock claw portion 96 projecting rightward is provided on the right end surface. The resilient lock frame body 94 is resiliently deformable in the lateral direction, and the back retainer 18 is configured by causing the divided retainers 42a, 42b to face each other in the vertical direction and engaging the resilient lock frame bodies 94 and the lock claw portions 96. That is, the separation of the upper and lower divided retainers 42a, 42b is hindered and the back retainer 18 is configured by engaging the resilient lock frame bodies 94 and the lock claw portions 96 in addition to the engagement of the lock claw portions 68 and the lock frame bodies 70.

Note that the resilient lock frame body 94 includes a pair of downward projecting portions 98, 98 separated from each other in the front-rear direction and projecting downward from the base portion 72 and a connecting portion 100 connecting projecting tip parts (lower end parts) of the respective downward projecting portions 98. The lock claw portion 96 is engaged in a region surrounded by these downward projecting portions 98 and connecting portion 100.

### First Engaging Portions 104 and Second Engaging Portions 108

Here, the back retainer 18 includes the first engaging portions 104 having squeeze ribs 102, 102 provided on the both sides in the first direction (vertical direction) and to be engaged with the first engaged portions 132 constituting later-described engaged portions 130 in the shield shell 24, and the second engaging portions 108 including the squeeze ribs 106, 106 provided on the both sides in the parallel direction (lateral direction) of the respective wires 16 and to be engaged with the second engaged portions 134 constituting the later-described engaged portions 130. As described later, a plurality of the first engaged portions 132 are arranged on the both sides in the lateral direction and a plurality of the second engaged portions 134 are provided on the both sides in the vertical direction in the wire pull-out opening 22 of the shield shell 24. Therefore, in the back retainer 18, a plurality of the first engaging portions 104 are arranged on the both sides in the lateral direction and a plurality of the second engaging portions 108 are arranged on the both sides in the vertical direction.

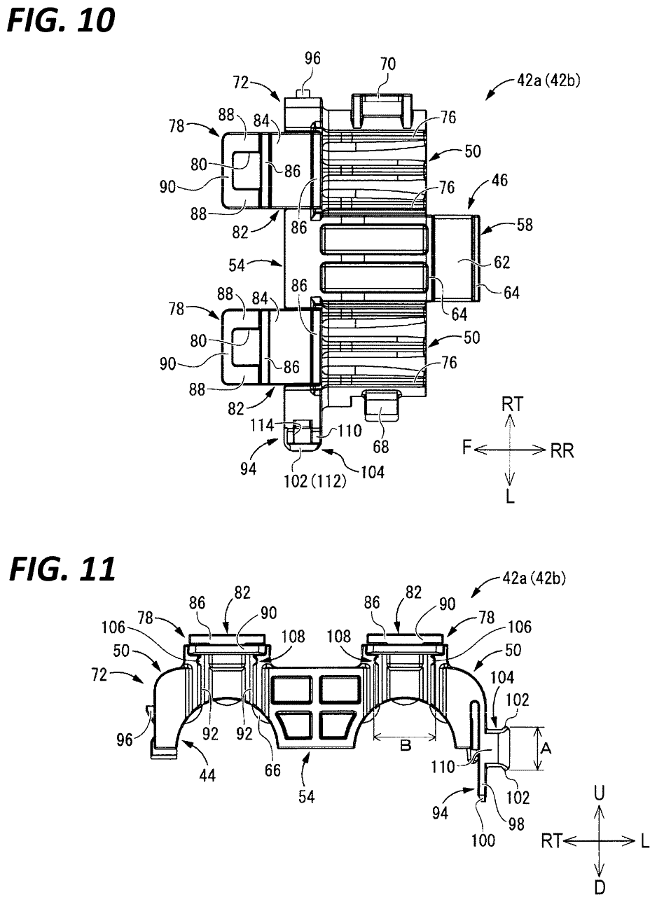

Specifically, in the divided retainer 42a, the first engaging portion 104 is formed to project toward an outer peripheral side (leftward) from the outer peripheral surface of the resilient lock frame body 94 provided in a left end part. That is, vertical wall portions 110, 110 projecting leftward and spreading in the vertical direction are provided in intermediate parts in the vertical direction of the pair of downward projecting portions 98, 98 separated in the front-rear direction in the resilient lock frame body 94. Further, the projecting tips (left ends) of the respective vertical wall portions 110 are coupled by a coupling wall portion 112. As also shown in FIGS. 8 and 10, a region surrounded by the respective vertical wall portions 110 and the coupling wall portion 112 forms a substantially rectangular through hole 114 penetrating in the vertical direction. The first engaging portion 104 is configured to include the respective vertical wall portions 110 and the coupling wall portion 112, and the squeeze ribs 102, 102 projecting further toward the both sides in the first direction (vertical direction) than the respective vertical wall portions 110 are provided on both upper and lower end surfaces of the coupling wall portion 112. By assembling the upper and lower divided retainers 42a, 42b thus shaped with each other in the vertical direction, the first engaging portions 104 are respectively provided on the both sides in the lateral direction of the back retainer 18. Further, since the first engaging portions 104 are provided to project from the outer peripheral surfaces of the resilient lock frame bodies 94 constituting the base portions 72, the first engaging portions 104 are also provided to project from the outer peripheral surface of the mounting tube portion 74 composed of the pair of base portions 72, 72.

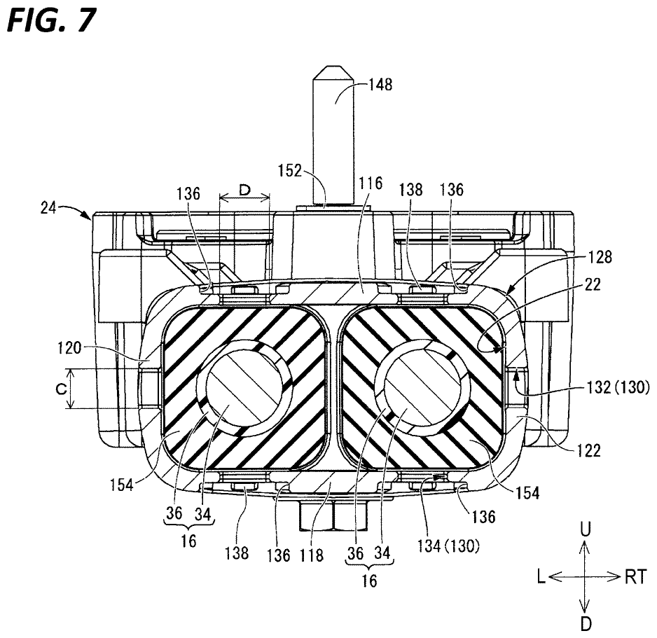

In a single state of the divided retainer 42a before the first engaging portion 104 is engaged with the first engaged portion 132 to be described later, a vertical dimension A (see FIG. 11) between the projecting tips of the respective squeeze ribs 102 is larger than a vertical dimension C (see FIG. 7) of the first engaged portion 132 to be described later. In this way, when the back retainer 18 is fit to the wire pull-out opening 22 and the first engaging portions 104 are fit to the respective first engaged portions 132, the respective first engaging portions 104 are pressed into contact with the respective first engaged portions 132 via the respective squeeze ribs 102 on the both sides in the first direction (vertical direction). Further, when being fit into the respective first engaged portions 132, the respective first engaging portions 104 are accommodated into the respective first engaged portions 132 without projecting toward the outer peripheral side of the wire pull-out opening 22.

Further, as described above, the squeeze ribs 106, 106 in the second engaging portion 108 are provided on the lateral outer surfaces of the respective downward extending portions 92 extending downward from each resilient lock piece 78 in the divided retainer 42a. Specifically, the respective squeeze ribs 106 are provided on upper end parts of the respective downward extending portions 92, and each second engaging portion 108 is configured to include the upper end parts of the respective downward extending portions 92. That is, each second engaging portion 108 having a projecting shape is configured to include the respective downward extending portions 92 projecting from each resilient lock piece 78 toward the wire 16 (downward) on the base end side (rear side) of each resilient lock piece 78 of the back retainer 18 (divided retainer 42a). By assembling the upper and lower divided retainers 42a, 42b thus shaped with each other in the vertical direction, the second engaging portions 108 are respectively provided on the both sides in the first direction (vertical direction) of the back retainer 18.

In the single state of the divided retainer 42a before the second engaging portions 108 are engaged with the second engaged portions 134 to be described later, a vertical dimension B (see FIG. 11) between the projecting tips of the respective squeeze ribs 106 is larger than a lateral dimension D (see FIG. 7) of the second engaged portion 134. In this way, when the back retainer 18 is fit to the wire pull-out opening 22 and the second engaging portions 108 are fit into the respective second engaged portions 134, the respective second engaging portions 108 are pressed into contact with the respective second engaged portions 134 via the respective squeeze ribs 106 on the both sides in the lateral direction. Note that, as shown in FIG. 3, a space may be provided in the lateral direction between the respective downward extending portions 92 and the respective downward extending portions 92 may be slightly resiliently deformable inward in facing directions when the respective squeeze ribs 106 are pressed into contact with the second engaging portion 134.

By shaping the divided retainer 42a in this way, a mold can be removed in the vertical direction during the molding of the divided retainer 42a. In this way, a cost increase is avoided without increasing types of molds. Further, also by forming the upper and lower divided retainers 42a, 42b to have the same shape, a cost reduction is realized by suppressing an increase in the number of types of components. Note that the upper and lower divided retainers need not necessarily have the same shape.

### Shield Shell 24

The shield shell 24 has a substantially tube shape open forward as a whole and covers the pair of connector housings 14, 14 substantially entirely. That is, the shield shell 24 includes an upper wall portion 116 for covering the respective connector housings 14 from above, a lower wall portion 118 for covering the respective connector housings 14 from below, a left wall portion 120 for covering the left connector housing 14 from left, a right wall portion 122 for covering the right connector housing 14 from right, and a front wall portion 124 for covering the respective connector housings 14 from front. Further, the shield shell 24 includes a partitioning portion 126 provided between the respective connector housings 14 in the lateral direction to partition an internal space of the shield shell 24 in the lateral direction.

This partitioning portion 126 extends rearward from the front wall portion 124 of the shield shell 24, but is formed to have such a dimension in the front-rear direction as not to reach the rear opening of the shield shell 24. In this way, the rear opening of the shield shell 24 has a substantially rectangular tube shape surrounded on four sides by the upper, lower, left and right wall portions 116, 118, 120 and 122 as also shown in FIGS. 3 and 7. The respective wires 16 pulled out rearward through the rear openings 40 of the respective connector housings 14 are pulled out to the outside of the shield shell 24 through the rear opening of the shield shell 24 having the substantially rectangular tube shape, and the tubular wire pull-out opening 22 is constituted by this rear opening of the shield shell 24.

Particularly, the tubular end part 128 is configured on the rear end part of the wire pull-out opening 22 of the shield shell 24 in the pull-out direction of the respective wires 16. That is, the tubular end part 128 is a substantially tubular part surrounded by the upper, lower, left and right wall portions 116, 118, 120 and 122 as described above, and parts spreading substantially flat are provided in lateral intermediate parts of the upper and lower wall portions 116, 118 and vertical intermediate parts of the left and right wall portions 120, 122. Further, in the tubular end part 128, the upper and lower wall portions 116, 118 are respectively connected to the left and right wall portions 120, 122 in both end parts in the lateral direction, and these connecting parts are configured to be curved to have round corners.

### Engaged Portions 130

Here, the wire pull-out opening 22 of the shield shell 24 is provided with a plurality of the engaged portions 130 separated from each other in a circumferential direction of the wire pull-out opening 22. Specifically, a plurality of cut-like engaged portions 130 are provided to penetrate in a plate thickness direction and be open in an end surface on the pull-out direction side (rear side) of the respective wires 16 in the tubular end part 128 of the wire pull-out opening 22. More particularly, in the tubular end part 128, the plurality of engaged portions 130 are provided on both sides in the first direction (vertical direction in this embodiment) orthogonal to the pull-out direction (front-rear direction) of the respective wires 16 and on both sides in the parallel direction of the respective wires 16 (lateral direction in this embodiment) orthogonal to both the extension direction of the respective wires 16 and the first direction. That is, the engaged portions 130 include the plurality of first engaged portions 132 arranged on the both sides in the lateral direction and the plurality of second engaged portions 134 arranged on the both sides in the vertical direction in the tubular end part 128. In short, as also shown in FIG. 7, the first engaged portions 132 are respectively provided in the left and right wall portions 120, 122 constituting the tubular end part 128 and the second engaged portions 134 are respectively provided in the upper and lower wall portions 116, 118 constituting the tubular end part 128.

The respective first engaged portions 132 are provided in the vertical intermediate parts spreading substantially flat in the left and right wall portions 120, 122 constituting the tubular end part 128, are open in the rear end surface of the tubular end part 128 and penetrate in the lateral direction, which is a plate thickness direction. These first engaged portions 132 have the predetermined vertical dimension C (see FIG. 7).

The respective second engaged portions 134 are provided in the lateral intermediate parts spreading substantially flat in the upper and lower wall portions 116, 118 constituting the tubular end part 128. In this embodiment, a pair of the second engaged portions 134, 134 are provided apart from each other in the lateral direction in each of the upper and lower wall portions 116, 118. The respective second engaged portions 134 are open in the rear end surface of the tubular end part 128, penetrate in the vertical direction, which is a plate thickness direction, and have the predetermined lateral dimension D (see FIG. 7).

### Lock Piece Accommodating Portions 136

Particularly, in this embodiment, recess-like lock piece accommodating portions 136 for accommodating the respective resilient lock pieces 78 of the back retainer 18 are provided to be open toward the outer peripheral side and rearward in the outer peripheral surface of the wire pull-out opening 22 in the shield shell 24. Specifically, a pair of the lock piece accommodating portions 136, 136 are separated from each other in the lateral direction and provided to be open vertically outward toward the outer peripheral side and rearward in the lateral intermediate part spreading substantially flat in each of the upper and lower wall portions 116, 118 constituting the wire pull-out opening 22 (tubular end part 128). The respective second engaged portions 134 described above penetrate in the vertical direction, which is the plate thickness direction, in the rear end surfaces of bottom parts of the respective lock piece accommodating portions 136, i.e. are provided to be open in the bottom surfaces of the respective lock piece accommodating portions 136. Further, lock projections 138 projecting vertically outward are provided on the outer peripheral surface of the wire pull-out opening 22. In this embodiment, the lock projection 138 projecting vertically outward is provided in front of each second engaged portion 134 on the bottom surface of each lock piece accommodating portion 136.

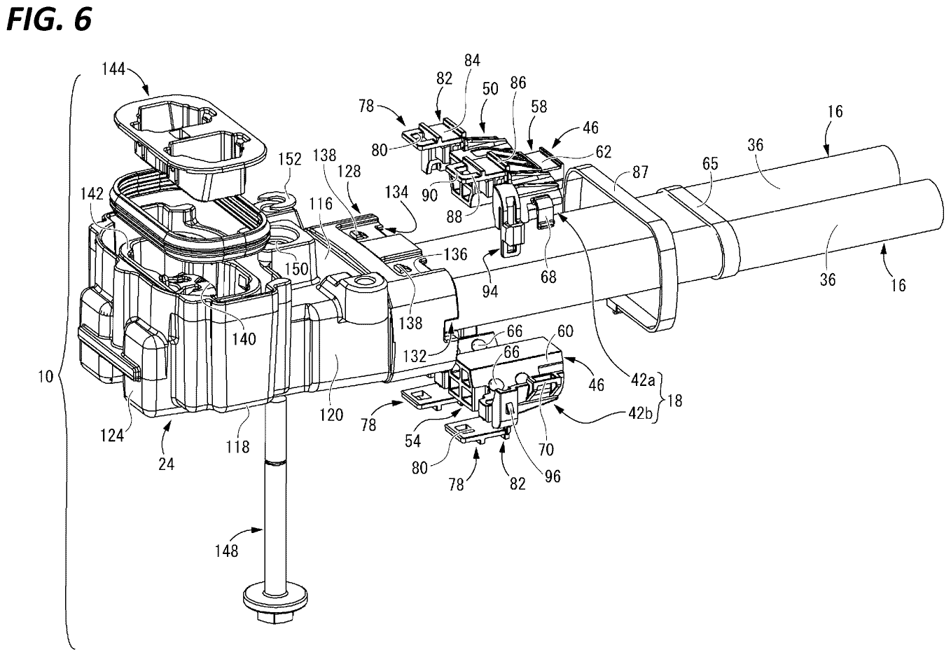

Note that, as shown in FIG. 6, a through hole 140 penetrating through the upper wall portion 116 in the thickness direction (vertical direction) is formed in a front part of the upper wall portion 116 of the shield shell 24, and the tubular connecting portions 26 of the respective terminals 12 arranged inside the shield shell 24 are exposed to an outside space through this through hole 140. Further, a tubular portion 142 projecting upward is provided on a peripheral edge part of the through hole 140 provided in the upper wall portion 116. The tubular portion 142 has a substantially oval shape having a lateral dimension larger than a front-rear dimension, and a front retainer 144 is mounted into this tubular portion 142. As shown in FIG. 2, substantially circular through holes 146 are formed to penetrate in the vertical direction at positions corresponding to the tubular connecting portions 26 of the respective terminals 12 in the front retainer 144, and the pin-shaped mating terminals are inserted into the tubular connecting portions 26 of the respective terminals 12 through these through holes 146 when the connector 10 and the mating connector are connected. Note that the tubular portion 142 and the front retainer 144 can be fixed to each other, for example, by an unillustrated locking mechanism or the like.

Further, a bolt insertion hole 150, into which a fastening bolt 148 is inserted, is formed to penetrate in the vertical direction behind the tubular portion 142 in a lateral central part of the shield shell 24. This fastening bolt 148 is, for example, fastened to an enclosure of a mating device in which the unillustrated mating terminals are provided, and the mating terminals can be press-fit into the tubular connecting portions 26 of the respective terminals 12, utilizing a fastening force of the fastening bolt 148. Note that the fastening bolt 148 inserted into the bolt insertion hole 150 can be prevented from coming out from the bolt insertion hole 150 by a fixing member 152 such as a C-ring.

Inside the shield shell 24, an annular waterproof rubber 154 is externally fit and mounted on each wire 16 pulled out rearward from the rear opening 40 of each connector housing 14. Each waterproof rubber 154 is inserted into the shield shell 24 through the rear opening (wire pull-out opening 22) of the shield shell 24, and located behind each connector housing 14. Further, as described above, the mounting tube portion 74 of the back retainer 18 is fit into the rear opening (wire pull-out opening 22) of the shield shell 24 to prevent the detachment of each waterproof rubber 154.

### Assembly of Connector 10

A specific example of an assembly method of the connector 10 is described below. Note that the assembly method of the connector 10 is not limited to the one described below.

First, the core wire 34 exposed by stripping the insulation coating 36 in the end of each wire 16 is fixed to the wire fixing portion 32 of each terminal body 28 and each clip spring 30 is attached to the front end part of each terminal body 28. In this way, each terminal 12 is connected to each wire 16. Then, each waterproof rubber 154 is externally fit and mounted on each wire 16.

Subsequently, each wire 16 assembled with the terminal 12 and the waterproof rubber 154 is inserted through the rear opening 40 of each connector housing 14. After each terminal 12 is inserted to a predetermined position, each connector housing 14 assembled with the terminal 12 is inserted through the rear opening (wire pull-out opening 22) of the shield shell 24 and each connector housing 14 and the shield shell 24 are fixed, for example, by fitting the projections and the recesses. Further, the front retainer 144 is mounted into the tubular portion 142 of the shield shell 24 from above. In this way, each wire 16 is pulled out to outside (rearward) through the wire pull-out opening 22 in the shield shell 24. Note that the fastening bolt 148 is inserted into the bolt insertion hole 150 at an appropriate timing.

Subsequently, as shown in FIG. 6, the upper and lower divided retainers 42a, 42b are caused to face each other in the vertical direction to vertically sandwich parts of the respective wires 16 pulled out rearward through the wire pull-out opening 22 of the shield shell 24. Thereafter, the upper and lower divided retainers 42a, 42b are brought closer in the vertical direction, and the respective lock claw portions 68 and the respective lock frame bodies 70, and the respective resilient lock frame bodies 94 and the respective lock claw portions 96 are engaged. In this way, the back retainer 18 is mounted on the respective wires 16 at a position separated rearward from the shield shell 24.

Subsequently, the back retainer 18 mounted on the respective wires 16 is moved forward toward the shield shell 24. In this way, the respective resilient lock pieces 78 projecting forward in the back retainer 18 are inserted into the respective lock piece accommodating portions 136 open rearward in the wire pull-out opening 22 of the shield shell 24 and accommodated into the respective lock piece accommodating portions 136. The respective resilient lock pieces 78 ride over the respective lock projections 138 provided on the bottom surfaces of the respective lock piece accommodating portions 136 while being resiliently deformed, whereby the respective lock projections 138 are fit into and engaged with the fitting holes 80 of the respective resilient lock pieces 78.

Further, the respective first engaging portions 104 and the respective second engaging portions 108 are inserted into the respective first engaged portions 132 and the respective second engaged portions 134, all of which are open rearward in the wire pull-out opening 22 of the shield shell 24. In this way, the respective squeeze ribs 102 in the first engaging portions 104 and the respective squeeze ribs 106 in the second engaging portions 108 are compressed and deformed by being squeezed by the respective first engaged portions 132 and the respective second engaged portions 134, whereby the respective first engaging portions 104 and the respective second engaging portions 108 are pressed into contact with the respective first engaged portions 132 and the respective second engaged portions 134. As a result, the back retainer 18 is fit to the wire pull-out opening 22 of the shield shell 24. In this state, the wire pressing protrusion 48 is arranged between the wires 16, 16 projecting from the wire inserting tube portions 20, 20 of the back retainer 18 and extending in the pull-out direction (rearward) (see FIG. 2).

Thereafter, the first binding band 65 is wound around between the upper and lower first band mounting portions 58 in the wire pressing protrusion 48 arranged between the wires 16, 16, and the wire pressing protrusion 48 in the back retainer 18 and the respective wires 16 are fixed by the first binding band 65. Further, the second binding band 87 is wound around between the upper and lower second band mounting portions 82 provided in the respective resilient lock pieces 78 and the back retainer 18 and the shield shell 24 are fixed by the second binding band 87. In this way, the connector 10 is completed.

According to the connector 10 of this embodiment structured as described above, the respective wires 16 projecting from the respective wire inserting tube portions 20 and extending in the pull-out direction (rearward) are bundled and fixed to each other while being held in close contact with the respective wire contact surfaces 56 in the wire pressing protrusion 48 by the first binding band 65 wound around between the respective first band mounting portions 58. Since the respective wires 16 and the back retainer 18 are fixed by the first binding band 65 in this way, the transmission of an external force input to the respective wires 16 due to vibration or the like to the side of the terminals 12 is prevented. Further, the first binding band 65 contacts the respective first band mounting portions 58 from the both sides in the vertical direction and presses the respective divided protrusions 46 of the upper and lower divided retainers 42a, 42b against each other from the both sides in the vertical direction. In this way, the upper and lower divided retainers 42a, 42b are suppressed from being displaced in the mutually opening directions (separating directions), and a state where the respective wires 16 are sandwiched by the respective divided tube portions 50 constituting the respective wire inserting tube portions 20 is stably maintained. As a result, not only the respective wires 16 are merely fixed by the first binding band 65, but also the formation of gaps between the respective wire inserting tube portions 20 and the respective wires 16 is suppressed by the first binding band 65, whereby an external force blocking effect can be more reliably exhibited.

The pair of wire contact surfaces 56, 56 of the wire pressing protrusion 48 are constituted by the curved surfaces convex inward in the facing directions thereof (lateral direction). In this way, each wire contact surface 56 can be shaped to substantially correspond to the outer peripheral surface of each wire 16 and a wide contact area between each wire contact surface 56 and the outer peripheral surface of each wire 16 can be ensured (see FIG. 5). As a result, the respective wires 16 can be stably held on the both sides in the lateral direction of the wire pressing protrusion 48 by the first binding band 65 and the external force blocking effect can be improved. Further, resistance in inserting the divided protrusions 46 between the respective wires 16 can be reduced and assemblability in assembling the upper and lower divided retainers 42a, 42b with the respective wires 16 can be improved, for example, as compared to the case where the respective wire contact surfaces are flat surfaces.

The first engaging portions 104 including the respective squeeze ribs 102 and the second engaging portions 108 including the respective squeeze ribs 106 in the back retainer 18 are fit into the plurality of engaged portions 130 (first and second engaged portions 132, 134) in the wire pull-out opening 22 of the shield shell 24. Particularly, the respective squeeze ribs 102, 106 are deformed to be squeezed against the respective first and second engaged portions 132, 134, whereby the respective first and second engaging portions 104, 108 are pressed into contact with the respective first and second engaged portions 132, 134. Thus, the rattling of the shield shell 24 and the back retainer 18 is prevented. In this way, even if an external force such as vibration input from outside is applied to the respective wires 16 and, for example, the respective wires 16 swing in the vertical direction or the lateral direction, the back retainer 18 is displaced with respect to the shield shell 24 to prevent the application of the external force to the respective terminals 12 connected to the respective wires 16.

The respective divided retainers 42a, 42b include the pair of second band mounting portions 82 arranged on the both sides in the vertical direction, and the upper and lower divided retainers 42a, 42b are pressed against each other from the both sides in the vertical direction and the back retainer 18 is tied and fixed to the wire pull-out opening 22 of the shield shell 24 by the second binding band 87 wound around between the respective second band mounting portions 82. As a result, the rattling of the back retainer 18 and the shield shell 24 is prevented by the second binding band 87, and the respective wires 16 can be fixed to the shield shell 24 via the back retainer 18. Particularly, in this embodiment, the second binding band 87 is provided to cover the engaged parts of the respective first engaging portions 104 and the respective first engaged portions 132 and the engaged parts of the respective second engaging portions 108 and the respective second engaged portions 134, which are fitting positions of the back retainer 18 and the shield shell 24, from the outer peripheral side. In this way, the rattling of the back retainer 18 and the shield shell 24 is prevented and the back retainer 18 and the shield shell 24 are prevented from being accidentally disengaged.

The respective first engaging portions 104 and the respective first engaged portions 132 are provided on the both sides in the lateral direction, and the respective second engaging portions 108 and the respective second engaged portions 134 are provided on the both sides in the vertical direction. In this way, the respective first engaging portions 104 and the respective first engaged portions 132, and the respective second engaging portions 108 and the respective second engaged portions 134 can be arranged symmetrically in the lateral direction and the vertical direction in the circumferential direction of the wire pull-out opening 22, and a displacement of the back retainer 18 with respect to the shield shell 24 can be further suppressed.

The respective wire pressing protuberances 66 of the back retainer 18 press the insulation coatings 36 of the respective wires 16 radially inward, whereby the respective wires 16 are press-fit, inserted and held in the respective wire inserting tube portions 20. In this way, a displacement amount of each wire 16 with respect to the back retainer 18 can be suppressed to be small. Particularly, in this embodiment, the plurality of wire pressing protuberances 66 arranged apart from each other in the circumferential direction in each wire inserting tube portion 20 are arranged apart from each other also in an axial direction and a displacement amount can be effectively suppressed also for a displacement (twist) of each wire 16 in a rotation direction.

The back retainer 18 includes the respective resilient lock pieces 78, the shield shell 24 includes the respective lock projections 138 and the respective lock projections 138 are fit into the respective resilient lock pieces 78, whereby the back retainer 18 is fit to the wire pull-out opening 22 of the shield shell 24. In this way, the assembly of the back retainer 18 with the shield shell 24 can be realized by a simple structure including the respective resilient lock pieces 78 and the respective lock projections 138. Further, since the shield shell 24 is provided with the respective lock piece accommodating portions 136 open in the outer peripheral surface to accommodate the respective resilient lock pieces 78, a projection amount of each resilient lock piece 78 from each lock piece accommodating portion 136 can be reduced or zeroed. In this way, the back retainer 18 and the shield shell 24 and, consequently, the connector 10 can be reduced in size. Further, it is also possible to reduce a possibility that the respective resilient lock pieces 78 and the respective lock projections 138 are accidentally disengaged and the back retainer 18 is detached from the shield shell 24. Particularly, in this embodiment, each resilient lock piece 78 is provided with the second band mounting portion 82. Thus, by mounting the second binding band 87 after the respective resilient lock pieces 78 and the respective lock projections 138 are fit, the respective resilient lock pieces 78 are further prevented from being accidentally displaced in a direction to be disengaged from the respective lock projections 138.

The second engaged portion 134 is provided in the bottom part of each lock piece accommodating portion 136 for accommodating the resilient lock piece 78, and the second engaging portion 108 to be press-fit into the second engaged portion 134 is provided on the base end side (rear side) of each resilient lock piece 78. That is, the respective lock piece accommodating portions 136 and the respective second engaged portions 134 are provided to be continuous in the vertical direction in the upper and lower wall portions 116, 118 of the shield shell 24, and the enlargement of the shield shell 24 can be avoided, for example, as compared to the case where lock piece accommodating portions and second engaged portions are provided at positions different in a circumferential direction of a wire pull-out opening. Similarly, the respective resilient lock pieces 78 and the respective second engaging portions 108 can be provided at the same positions in the circumferential direction of the mounting tube portion 74 in the back retainer 18 and the enlargement of the back retainer 18 can also be avoided.

With the back retainer 18 fit to the shield shell 24, the respective first engaging portions 104 are accommodated in the respective first engaged portions 132 without projecting toward the outer peripheral side of the wire pull-out opening 22. In this way, the respective first engaging portions 104 can be prevented from being accidentally disengaged from the respective first engaged portions 132 due to the contact of another member or a worker or the like.

### Modifications

Although the embodiment has been described in detail as a specific example of the present disclosure above, the present disclosure is not limited by this specific description. The present disclosure includes modifications, improvements and the like within a range in which the aim of the present disclosure can be achieved. For example, the following modifications of the embodiment are also included in the technical scope of the present disclosure.

(1) The shape of the terminal 12 in the above embodiment is merely illustrative, rather than restrictive. That is, although the terminal 12 includes the tubular connecting portion 26, into which the pin-shaped mating terminal is inserted, in the above embodiment, there is no limitation to this mode. A mating terminal may have a flat tab shape, for example, as described in International Publication No. WO 2021/145197. In that case, the terminal may include a substantially rectangular terminal insertion gap.

(2) Although the plurality of first engaging portions 104 and the plurality of second engaging portions 108 are provided and the plurality of first engaged portions 132 and the plurality of second engaged portions 134 are provided to correspond to these first engaging portions 104 and second engaging portions 108 in the above embodiment, there is no limitation to this mode. That is, in a connector according to the present disclosure, the numbers of first engaging portions and second engaging portions are not limited, but one or more first engaging portions and one or more second engaging portions may be provided and one or more first engaged portions and one or more second engaged portions may be provided to correspond to these first engaging portions and second engaging portions. Note that, in the connector according to the present disclosure, the first and second engaging portions and the first and second engaging portions are not essential and may not be provided.

(3) Although the respective lock piece accommodating portions 136 are provided in the outer peripheral surface of the wire pull-out opening 22 in the shield shell 24 and the respective lock projections 138 are provided on the bottom surfaces of the respective lock piece accommodating portions 136 in the above embodiment, there is no limitation to this mode. That is, in a connector according to the present disclosure, lock piece accommodating portions may not be provided. For example, lock projections may project toward an outer peripheral side from the outer peripheral surface of a wire pull-out opening in a shield shell and, in that case, resilient lock pieces are arranged to overlap the outer peripheral surface of the wire pull-out opening in the shield shell.

(4) Although the respective resilient lock pieces 78 are provided on the outer peripheral sides (vertical outer sides) of the respective second engaging portions 108 in the above embodiment, resilient lock pieces may be provided on outer peripheral sides of first engaging portions instead of or in addition to second engaging portions. That is, although the respective resilient lock pieces 78 are provided on the both sides in the vertical direction of the back retainer 18 in the above embodiment, resilient lock piece(s) may be provided on one or both sides in the lateral direction of a back retainer and engaged with lock projection(s) provided on one or both sides in the lateral direction of a shield shell. Note that the resilient lock pieces are not essential in the connector according to the present disclosure.

(5) Although the back retainer 18 is composed of the pair of divided retainers 42a, 42b having the same shape in the above embodiment, a pair of divided retainers may have mutually different shapes. Note that the pair of divided retainers may be integrally formed. For example, a hinge portion may be provided on one end part in the circumferential direction of each divided retainer to make the respective divided retainers openable and closable, and the respective divided retainers may be fixed to each other by a locking mechanism or the like provided on the other end part in the circumferential direction of each divided retainer after wires are sandwiched.

(6) Although the outer peripheral surfaces of the respective wires 16 are held in close contact with the substantially entire wire contact surfaces 56 on the both left and right sides in the wire pressing protrusion 48 in the above embodiment, the outer peripheral surfaces of the respective wires and the respective wire contact surfaces may be at least partially held in close contact with each other. Further, although the respective wire contact surfaces 56 are constituted by the curved surfaces convex inward in the facing directions (lateral direction) in the above embodiment, wire contact surfaces may be, for example, vertical surfaces spreading in the vertical direction and lateral inner parts of insulation coatings of the respective wires may be pressed and deformed by the wire contact surfaces spreading in the vertical direction.

(7) Although the second binding band 87 is provided in addition to the first binding band 65 in the above embodiment, a second binding band may not be provided in a connector according to the present disclosure. Further, the shapes of first and second band mounting portions, through which first and second binding bands are mounted, are not limited and may be tube shapes or frame shapes in addition to gutter shapes as in the above embodiment.

(8) A back retainer only has to be assembled with a connector housing, and may be directly assembled with the connector housing or indirectly assembled with the connector housing via another member assembled with the connector housing such as a shield shell. That is, the shield shell is not essential in the connector according to the present disclosure.

### LIST OF REFERENCE NUMERALS

10 connector
12 terminal
14 connector housing
16 wire
18 back retainer
20 wire inserting tube portion
22 wire pull-out opening
24 shield shell
26 tubular connecting portion
28 terminal body
30 clip spring
32 wire fixing portion
34 core wire
36 insulation coating
38 terminal accommodating portion
40 rear opening
42a, 42b divided retainer
44 recessed groove
46 divided protrusion
48 wire pressing protrusion
50 divided tube portion
52 gap
54 coupling portion
56 wire contact surface
58 first band mounting portion
60 divided contact surface
62 flat surface
64 side edge part
65 first binding band
66 wire pressing protuberance
68 lock claw portion
70 lock frame body
72 base portion
74 mounting tube portion
76 rib
78 resilient lock piece
80 fitting hole
82 second band mounting portion
84 flat surface
86 side edge part
87 second binding band
88 forward projecting portion
90 connecting portion
92 downward extending portion
94 resilient lock frame body
96 lock claw portion
98 downward projecting portion
100 connecting portion
102 squeeze rib
104 first engaging portion
106 squeeze rib
108 second engaging portion
110 vertical wall portion
112 coupling wall portion
114 through hole
116 upper wall portion
118 lower wall portion
120 left wall portion
122 right wall portion
124 front wall portion
126 partitioning portion
128 tubular end part
130 engaged portion
132 first engaged portion
134 second engaged portion
136 lock piece accommodating portion
138 lock projection
140 through hole
142 tubular portion
144 front retainer
146 through hole
148 fastening bolt
150 bolt insertion hole
152 fixing member
154 waterproof rubber

1. A connector, comprising:
a plurality of terminals accommodated in a connector housing;
a plurality of wires respectively connected to the plurality of terminals, the plurality of wires being pulled out in parallel to outside of the connector housing while being separated from each other across a gap; and
a back retainer made of synthetic resin, the back retainer including a plurality of wire inserting tube portions for holding the plurality of wires pulled out to the outside of the connector housing, the plurality of wires being press-fit and inserted into the plurality of wire inserting tube portions, the back retainer being assembled with the connector housing,
the back retainer including a pair of divided retainers to be fixed to each other while sandwiching and holding the wires from both sides in a direction perpendicular to an axis of each wire,
each of the pair of divided retainers including a plurality of recessed grooves to be respectively held in close contact with outer peripheral surfaces of the plurality of wires and a divided protrusion located between the plurality of recessed grooves in a parallel direction of the plurality of wires and projecting in a pull-out direction of the plurality of wires,
the pair of divided retainers being fixed to each other to define the plurality of wire inserting tube portions arranged in parallel by the plurality of recessed grooves, the divided protrusions being combined to configure a wire pressing protrusion arranged between the plurality of wires projecting from the plurality of wire inserting tube portions and extending in the pull-out direction,
the wire pressing protrusion including a pair of wire contact surfaces to be held in contact with the wires arranged on both sides in the parallel direction and a pair of first band mounting portions provided on end surfaces on both sides in a first direction orthogonal to facing directions of the pair of wire contact surfaces, and
the plurality of wires projecting from the plurality of wire inserting tube portions and extending in the pull-out direction being bundled and fixed to each other by a first binding band wound around between the pair of first band mounting portions while being respectively held in close contact with the pair of wire contact surfaces of the wire pressing protrusion of the back retainer, the first binding band contacting the pair of first band mounting portions from the both sides in the first direction to press the respective divided protrusions of the pair of divided retainers constituting the wire pressing protrusion from the both sides in the first direction.

2. The connector of claim 1, wherein the pair of wire contact surfaces of the wire pressing protrusion are constituted by curved surfaces convex inward in the facing directions of the wire contact surfaces.

3. The connector of claim 1, further comprising a shield shell made of metal, the shield shell covering the connector housing by being fixed to the connector housing, the shield shell including a tubular wire pull-out opening, the plurality of wires pulled out to the outside of the connector housing being pulled out through the wire pull-out opening, the back retainer being fit to the wire pull-out opening of the shield shell, wherein:
the wire pull-out opening of the shield shell includes a plurality of engaged portions provided apart from each other in a circumferential direction of the wire pull-out opening,
the back retainer includes a first engaging portion including squeeze ribs provided on both sides in the first direction and to be engaged with the engaged portion and a second engaging portion including squeeze ribs provided on both sides in the parallel direction and to be engaged with the engaged portion, and
the first engaging portion is pressed into contact with the engaged portion via the squeeze ribs on the both sides in the first direction and the second engaging portion is pressed into contact with the engaged portion via the squeeze ribs on the both sides in the parallel direction with the back retainer fit to the wire pull-out opening.

4. The connector of claim 3, wherein:
each divided retainer includes a second band mounting portion provided on an end side opposite to the divided protrusion in the pull-out direction and the back retainer configured by assembling the divided retainers with each other includes a pair of the second band mounting portions arranged on both sides in the first direction, and
the pair of divided retainers are pressed against each other from the both sides in the first direction and the back retainer is tied and fixed to the wire pull-out opening of the shield shell by a second binding band wound around between the pair of second band mounting portions.

5. The connector of claim 3, wherein:
the plurality of engaged portions of the wire pull-out opening include a plurality of first engaged portions arranged on the both sides in the parallel direction and a plurality of second engaged portions arranged on the both sides in the first direction,
the back retainer includes a plurality of the first engaging portions arranged on the both sides in the parallel direction and a plurality of the second engaging portions arranged on the both sides in the first direction, and
the first engaging portions are pressed into contact with the first engaged portions on the both sides in the parallel direction via the squeeze ribs on the both sides in the first direction and the second engaging portions are pressed into contact with the second engaged portions on the both sides in the first direction via the squeeze ribs on the both sides in the parallel direction with the back retainer fit to the wire pull-out opening.

6. The connector of claim 1, wherein:
a diameter of an inner peripheral surface of each wire inserting tube portion of the back retainer is larger than a diameter of the outer peripheral surface of each wire inserted through inside of the wire inserting tube portion,
a plurality of wire pressing protuberances projecting further radially inward than the outer peripheral surface of each wire are provided to project away from each other on the inner peripheral surface of each wire inserting tube portion, and
the respective wire pressing protuberances press an insulation coating constituting the outer peripheral surface of each wire radially inward, whereby the wire is press-fit, inserted and held in the wire inserting tube portion.

7. The connector of claim 3, wherein:
the back retainer includes a resilient lock piece cantilevered toward the wire pull-out opening of the shield shell, the resilient lock piece including a fitting hole in a projecting end part,
the shield shell includes a lock projection projecting on an outer peripheral surface of the wire pull-out opening, and
the back retainer is fit to the wire pull-out opening of the shield shell by fitting the lock projection of the shield shell into the fitting hole of the resilient lock piece of the back retainer.

8. The connector of claim 7, wherein:
the wire pull-out opening of the shield shell includes a recess-like lock piece accommodating portion open in the outer peripheral surface of the wire pull-out opening and the lock projection projects on a bottom surface of the lock piece accommodating portion, and
the resilient lock piece of the back retainer is accommodated in the lock piece accommodating portion with the back retainer fit to the shield shell.

9. The connector of claim 8, wherein:
the wire pull-out opening of the shield shell is provided with the plurality of cut-like engaged portions penetrating in a plate thickness direction and open in an end surface on the pull-out direction side of the wires in a tubular end part located on the pull-out direction side,
at least one of the engaged portions is provided to be open in the bottom surface of the lock piece accommodating portion, and
the second engaging portion having a projecting shape, projecting from the resilient lock piece toward the wire and to be press-fit into the at least one of the engaged portions is provided on a base end side of the resilient lock piece of the back retainer.

10. The connector of claim 9, wherein:
the back retainer includes a mounting tube portion to be fit into an inner peripheral side of the tubular end part of the wire pull-out opening and the first engaging portion having a projecting shape and projecting on an outer peripheral surface of the mounting tube portion, and
the first engaging portion is accommodated in the engaged portion without projecting toward an outer peripheral side of the wire pull-out opening with the back retainer fit to the shield shell.
